(19) United States
(12) Patent Application Publication
(10) Pub. No.: US 2002/0052565 A1
(43) Pub. Date: May 2, 2002

(54) Multi-function portable health and beauty device

(76) Inventor: Masaki Wada, Osaka-shi (JP)

Correspondence Address: FLYNN, THIEL, BOUTELL & TANIS, P.C., 2026 Rambling Road, Kalamazoo, MI, 49008-1699, US

(21) Appl. No.: 09/880,441

(22) Filed: Jun. 13, 2001

(30) Foreign Application Priority Data
Oct. 30, 2000 (JP) 2000-331086

(51) Int. Cl. A61H 7/00

(52) U.S. Cl. 601/103; 601/99

(57) ABSTRACT

A multi-function portable health and beauty device which can be easily carried and which includes treatment members used to enlarge the area of the device which makes contact with the areas of the body to be treated to promote circulation of the blood and burning of fat. The device includes a base which has a central recessed part into which the areas to be treated can be placed; a drive mechanism mounted on the base; and rotating treatment members which are installed on the base so that they are generally parallel to the drive mechanism and so that they interlock with the drive mechanism and rotate. Expansion and contraction members are also provided at both sides of the recessed part of the base and are supplied with air using an air supply source. A vibration mechanism is also provided to vibrate the inside of the recessed part of the base or the rotating treatment members.

### FIELD OF THE INVENTION

The present invention relates to a health and beauty device on which are disposed rollers which can rotate freely. It relates specifically to a compact multi-function portable health and beauty device which provides home medical treatment for arms, calves, thighs and other parts of the human body which have adipose tissue as well as the nape of the neck and other areas of the body and which burns fat and promotes blood circulation in these areas.

### BACKGROUND OF THE INVENTION

Prior art health and beauty devices of this type include portable massage devices which can be easily carried about, which are efficient and which can be used at home for self treatment. Since these were inexpensive and easy to use, they were greatly valued by the general user.

A typical prior art portable massage device of this type was provided with a large number of treatment members which could rotate freely around a cylindrical rotor. The aforementioned treatment members provided a rolling type of treatment which involved rubbing while making contact with the area of the body to be treated. The device was provided with a pair of eccentric members which faced the center and which could also carry out treatment by rubbing areas of the human body. The device was pleasant to use, was able to promote blood circulation in the areas treated and was able to provide relief due to tiring of the muscles and muscle tension so that it had a high treatment efficiency.

The large number of treatment members which were disposed on the periphery of the cylindrical rotor in the prior art portable massage device made point contact with the areas of the body of the person using the device and provided a rolling type of treatment. As a result, there were problems in that the device was heavy and only point treatment could be carried out using only the top of the outside periphery of the cylindrical rotor which made it impossible to carry out treatment which involved covering an entire area of the body.

In addition, although this type of portable massage device could be used to carry out massages by using the outside peripheral protruding side of the cylindrical rotor, the treatment areas themselves were curved surfaces and attempts were made to provide treatment of these areas of the human body using the protruding surface of the rotor. As a result, when the protruding surfaces made contact with the areas of the body to be treated, a bounce or repulsion occurred and the force of contact with that point on the area to be treated was concentrated and hurt the person being treated, thus making the device hazardous.

Despite this, as health concerns have increased in recent years, there has been a strong demand to eliminate excess fat from the human body. There has been a particularly strong demand for a means of removing excess fat from the upper arms and ankles as well as from the calves and thighs and other parts of the human body which have comparatively large deposits of fat. There has been a strong demand for development of a health and beauty device which can be used effectively for home treatment of these areas and which can burn fat efficiently.

The present invention was developed to take the above into consideration and to provide a multi-function portable health and beauty device which can be used efficiently to concentrate on the areas of the body with comparatively large deposits of fat, which can promote circulation of the blood in the areas of the body treated using this treatment and which can burn fat.

It is also an object of the present invention to provide a multi-function health and beauty device in which the members of the device used for treatment can efficiently make contact with the areas of the human body to be treated and which can increase the area in which the treatment device members make contact with the parts of the body to be treated.

It is yet another object of the present invention to provide a multi-function portable health and beauty device which makes it possible to provide treatment for areas of the human body with different diameters as well as for those areas of the body with comparatively little deposits of fat and which can be adapted for treatment of large areas of the human body too.

It is still another object of the present invention to provide a multi-function portable health and beauty device which can provide comparatively large and uniform rubbing contact force on the areas of the body to be treated using a small amount of drive force.

The multi-function portable health and beauty device in the present device has attained the aforementioned objectives and is configured as follows.

In other words, the multi-function portable health and beauty device in the present invention is configured of (1) a base which has a recessed part in the middle into which the areas of the human body to be treated can be inserted or placed; (2) a drive mechanism which is retained on at least one side of the aforementioned base; and (3) rotating treatment members which are installed in the middle of the base so that they interlock with the aforementioned drive mechanism and rotate.

The multi-function portable health and beauty device in the present invention is also provided with a support part on both sides and is configured of (1) a base which has a recessed part in the middle in which the areas of the body to be treated can be inserted or placed; (2) a drive mechanism which is placed inside the support part on at least one side of the aforementioned base; and (3) rotating treatment members which are installed at the center of the base so that they interlock with the aforementioned drive mechanism and rotate.

The present invention is also configured of expanding and contracting members, disposed on both sides of the recessed part of the aforementioned base, all of which either repeatedly expand and contract or expand and retain this expanded shape, by supplying air using an air supply means.

The present invention features a vibration mechanism disposed on the base, which mechanically vibrates either the inside of the recessed part of the base or vibrates the rotating treatment members.

The aforementioned rotating treatment members in the present invention are equipped with contact members which are made up of (1) a pair of plate-shaped members which are pivoted at constant intervals on an installation shaft which is installed in the middle of the base; and (2) multiple rotating members which are disposed on the periphery between both of these plate-shaped members.

The present invention has a drive mechanism or a drive battery disposed on the support part on the other side of the aforementioned base, which has the same schematic weight as the aforementioned drive mechanism.

The present invention is provided with a control means, located on the aforementioned drive mechanism or the aforementioned air supply means, which (1) controls the rotation and stopping of the treatment members; and (2) automatically controls the repeated expansion and contraction or the expansion and retention, as well as the stopping of the expansion and contraction members.

As a result, the multi-function portable health and beauty device of the present invention operates as follows thanks to the configurations mentioned above.

In other words, the present invention includes a drive mechanism on at least one side of the base, which base has a recessed part in the middle in which the areas of the body to be treated can be inserted or placed, and rotating treatment members which are installed in the middle of the base and which interlock with the aforementioned drive mechanism. As a result, the device is compact in design and can be manufactured inexpensively. Further, the device promotes blood circulation in the areas of the body treated and it can be used to burn fat.

The present invention is provided with a support part on both sides and has an internally placed drive mechanism located on at least one of these support parts, and a recessed part in the middle in which the areas of the body to be treated can be inserted or placed. Thus, the outside shape of the device can be made so that it is compact. The treatment members which are installed at the middle of the base and which interlock with this drive mechanism can be rotated. As a result, the single and multiple rotating treatment members make contact with the areas of the body to be treated and rotate regardless of the number of rotating treatment members used. The blood circulation of the areas treated can be promoted and treatment which burns fat can be carried out.

The present invention has a drive mechanism installed on the support part on at least one side of the base which has a recessed part in the middle in which the areas of the body to be treated can be inserted or placed. Rotating treatment members which interlock with the aforementioned drive mechanism and rotate are disposed in the middle of the base. Expansion and contraction members all of which either repeatedly expand and contract or which expand, contract and retain this expanded configuration by supplying air provided by an air supply means are disposed close to both sides of the recessed part of the aforementioned base. As a result, the treatment operations using the rotating treatment members and the pressure treatment using the expansion and contraction members can be carried out either simultaneously or separately at any given time. In addition, treatment can be carried out using the rotating treatment members while retaining and clamping the areas of the body to be treated using the expansion and contraction members thus making it possible to burn fat in a highly efficient manner which enhances the treatment effect for the areas of the body to be treated.

In the present invention a vibration mechanism is disposed on the base which mechanically vibrates either the inside of the recessed part on the base or vibrates the rotating treatment members of the device, so that slight vibrations which help to burn fat can be provided for the areas of the body which are being treated inside the recessed part. Slight concentrated vibrations can be provided for designated areas of the body which are to be treated via the rotating treatment members. Further, slight vibrations caused by the vibration mechanism and a treatment effect which uses the rotating treatment members can be carried out simultaneously.

The present invention uses rotating treatment members which are provided with contact members made up of (1) a pair of plate-shaped members which are pivoted at constant intervals on an installation shaft which is installed in the middle of the base; and (2) multiple rotating members which are disposed on the periphery between both plate-shaped members. As a result, it is possible to change as appropriate (a) the disposition status and the attachment status of the treatment members which are provided with contact members made up of (1) a pair of plate-shaped members; and (2) multiple rotating members which are disposed between both plate-shaped members; or (b) the disposition and attachment status of the multiple treatment members. As a result, the length of the protrusion of the treatment members inside the recessed part and the contact sensation can be changed and a comparatively uniform rubbing and contact force can be provided for the areas of the body to be treated using a small amount of driving force.

The invention is configured with (1) an internally placed drive mechanism mounted on the support part on at least one side of the aforementioned base; and (2) a drive mechanism or a drive battery, internally placed on the support part on the other side of the base which has the same schematic weight as the aforementioned drive mechanism. As a result, the device can be held so that it is stable with equal weights on the left and right sides even when the person using the device holds the support part and the other areas. It is pleasant to hold and use and has a compact design.

The present invention is also provided with a control means disposed on the aforementioned drive mechanism and air supply means, which controls (1) the rotation and stopping of the rotating treatment members and (2) the repeated expansion and contraction or expansion and retention, as well as the stopping of the expansion and contraction members. As a result, these can be controlled automatically by using a program which has been preset. The rubbing treatment effect using the rotating treatment members and the pressure treatment effect using the expansion and contraction members are controlled according to the aforementioned program. In addition to the rubbing treatment using the rotating treatment members and the pressure treatment using the expansion and contraction members, rubbing treatment is carried out using the rotating treatment members while the treatment areas are increased and retained using the expansion and contraction members, thus completing the treatment. The automatic treatment effect for the areas of the body to be treated can be carried out efficiently and body fat can be burned at a high efficiency using the treatment which is suitable for the areas to be treated.

### BRIEF DESCRIPTION OF THE DRAWINGS

FIG. 1 is a perspective view of a practical embodiment of the multi-function portable health and beauty device according to the present invention.

FIG. 2 is a perspective view of a practical embodiment of the multi-function portable health and beauty device including a cover.

FIG. 3 is an explanatory side view of the FIG. 1 embodiment.

FIG. 4 is an explanatory plan view of the FIG. 1 embodiment.

FIG. 5 is a perspective view of a further embodiment according to the present invention including a cover.

FIG. 6 is a perspective view of the FIG. 5 embodiment without the cover.

FIG. 7 is an explanatory side view of the FIG. 6 embodiment.

FIG. 8 is an explanatory plan view of the FIG. 6 embodiment.

FIG. 9 is a perspective view of a further embodiment according to the present invention.

FIG. 10 is an explanatory side view of the FIG. 9 embodiment.

FIG. 11 is a perspective view of the FIG. 9 embodiment including a cover.

FIG. 12 is a perspective view of a further embodiment utilizing the treatment members of FIG. 19.

FIG. 13 is a perspective view of a further embodiment utilizing the treatment members of FIG. 21.

FIG. 14 is a perspective view of a further embodiment utilizing the treatment members of FIG. 22.

FIG. 15 is a perspective view of a further embodiment utilizing the treatment members of FIG. 20.

FIG. 16 is an explanatory side view of a further embodiment according to the present invention.

FIG. 17 is an explanatory plan view of a further embodiment according to the present invention.

FIG. 18 is an explanatory plan view of a further embodiment according to the present invention.

FIG. 19 is a perspective view of a rotating treatment member.

FIG. 20 is a perspective view of a further embodiment of the rotating treatment member.

FIG. 21 is a perspective view of a further embodiment of the rotating treatment member.

FIG. 22 is a perspective view of a further embodiment of the rotating treatment member.

FIG. 23 is an explanatory view of the multifunction portable health and beauty device in use on the arm.

FIG. 24 is an explanatory view of the multifunction portable health and beauty device in use on the lower leg.

FIG. 25 is an explanatory view of the multifunction portable health and beauty device in use on the thigh.

FIG. 26 is an explanatory view of the multifunction portable health and beauty device with an attachment belt.

FIG. 27 is an explanatory view of a pair of multi-function portable health and beauty devices with two attachment belts.

FIG. 28 is a schematic block diagram of a practical embodiment of the control means which is used to control the drive mechanism and the air supply means in the multi-function portable health and beauty device according to the present invention.

### DETAILED DESCRIPTION

Next, we shall explain in detail the multifunction portable health and beauty device of the present invention based on practical embodiments illustrated in the drawings.

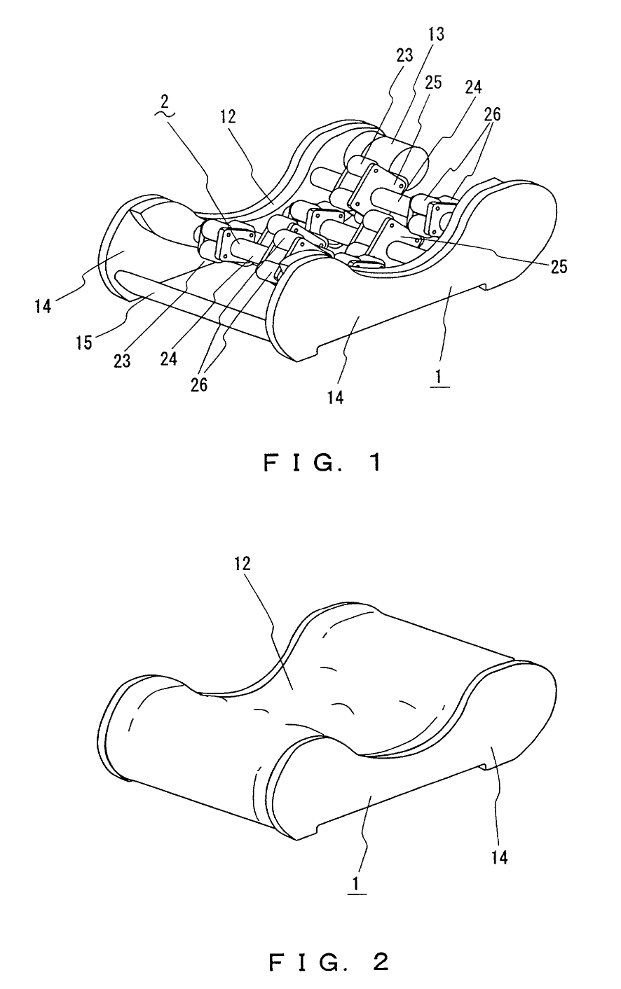

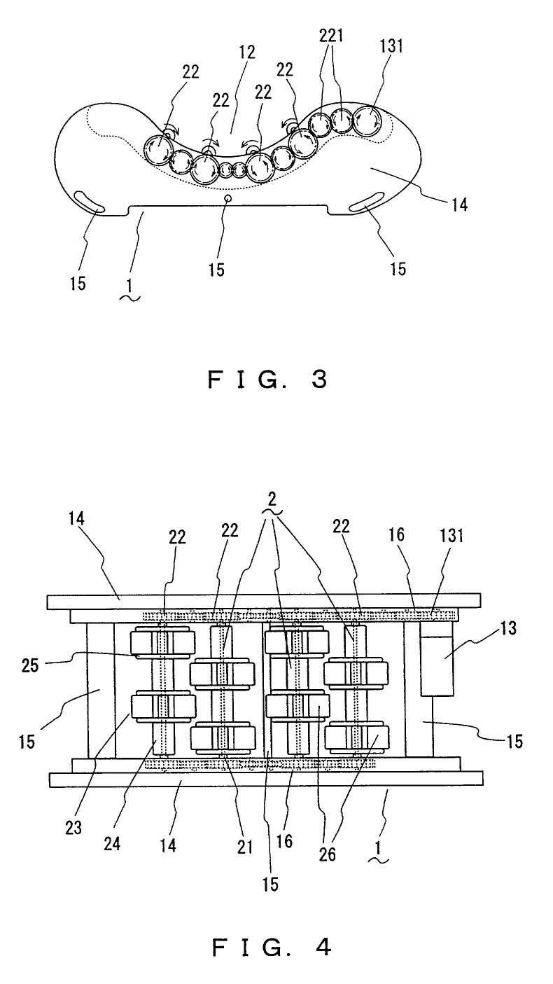

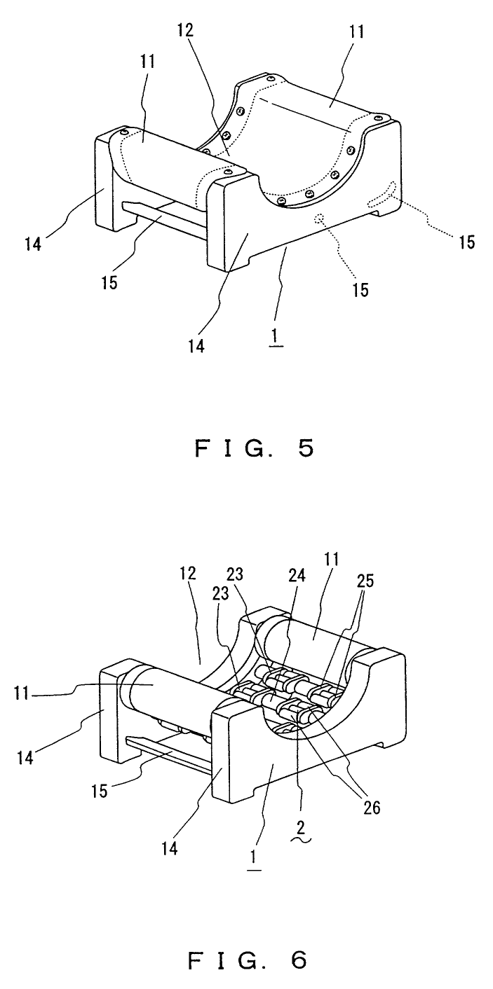

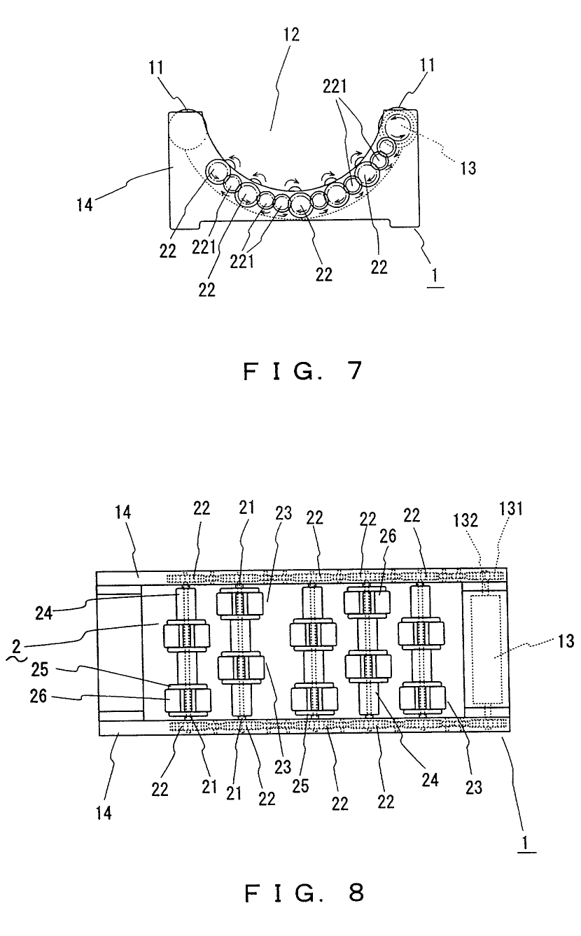

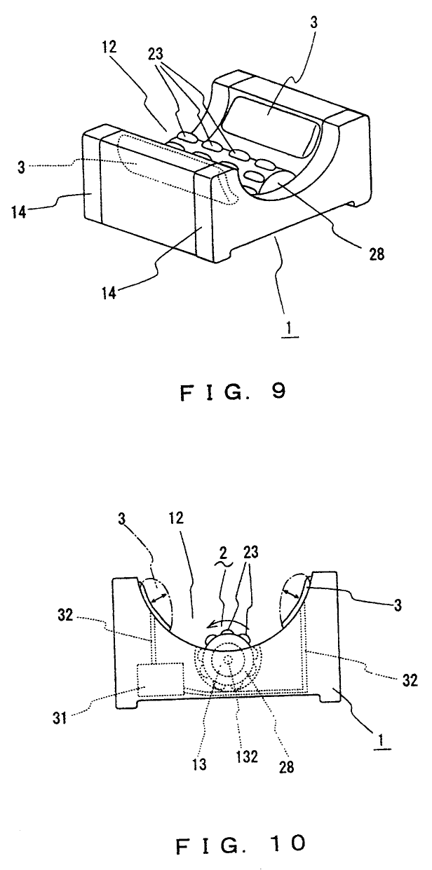

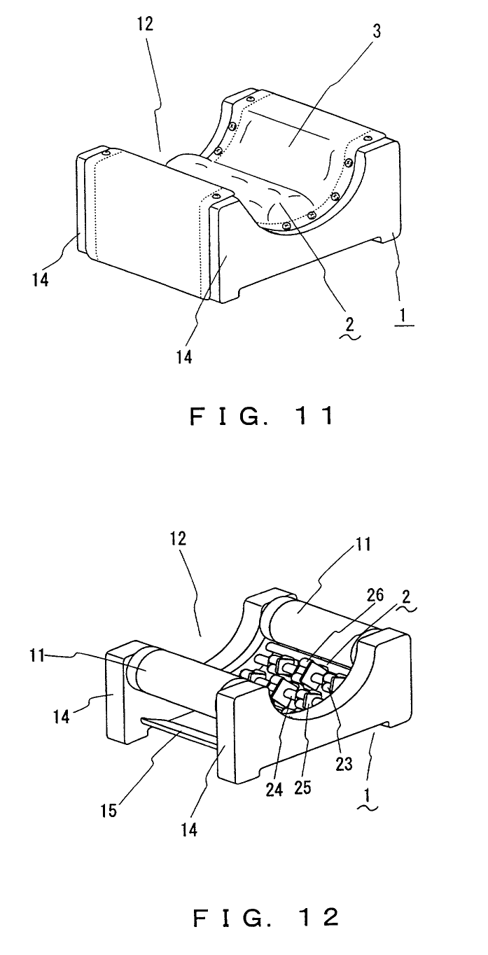

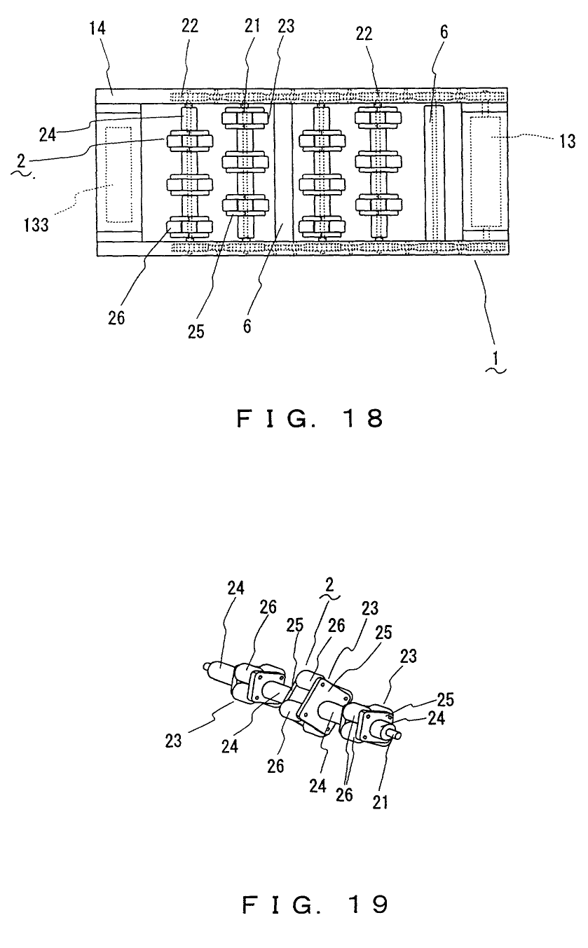

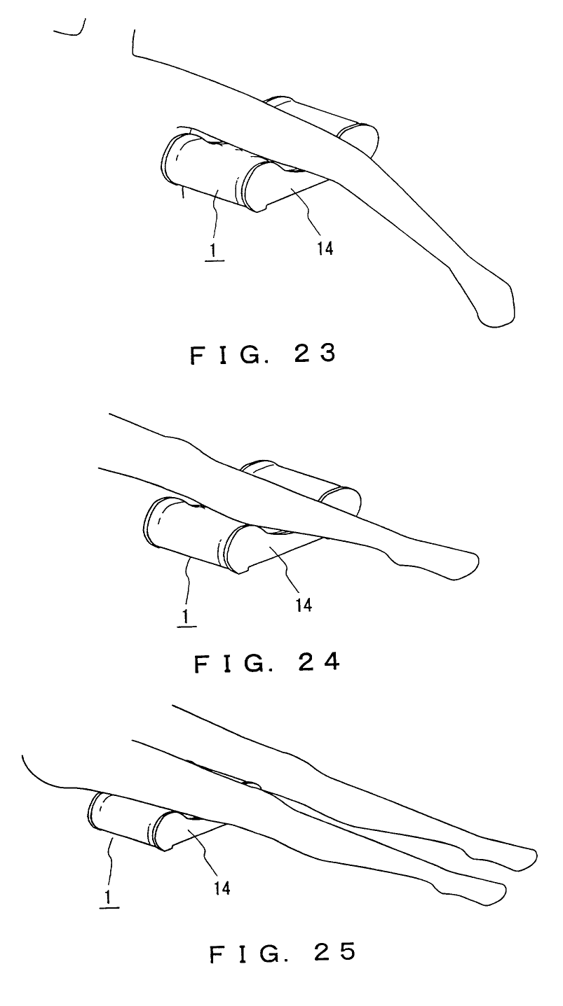

FIG. 1, FIG. 2, FIG. 5, FIG. 6, FIG. 9 and FIG. 11 through FIG. 15 are inclined views of each of the practical embodiments of the multi-function portable health and beauty device of the present invention. FIG. 3, FIG. 4, FIG. 7, FIG. 8, FIG. 10 and FIG. 16 through FIG. 18 are explanatory diagrams of each of the practical embodiments of the multi-function portable health and beauty device of the present invention. FIG. 19 through FIG. 22 are inclined views of practical embodiments of a variety of types of rotating treatment members in the multi-function portable health and beauty device of the present invention. FIG. 23 through FIG. 27 are explanatory views of embodiments showing uses of the multi-function portable health and beauty device of the present invention. FIG. 28 is a schematic block diagram of a practical embodiment of the control means which controls the drive mechanism and the air supply means in the multi-function portable health and beauty device of the present invention.

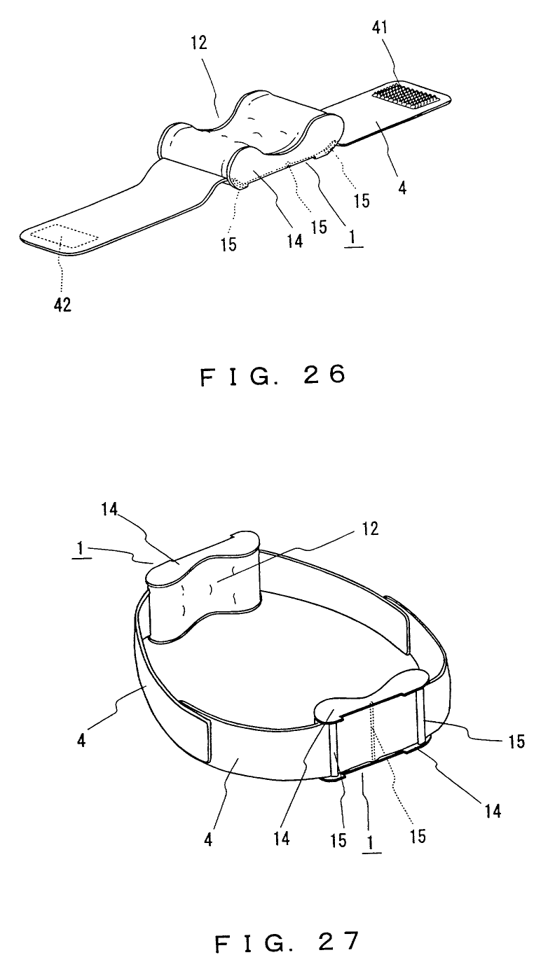

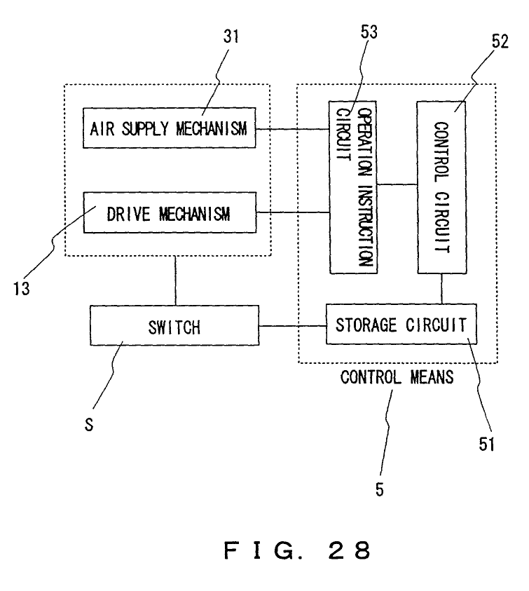

In other words, the multi-function portable health and beauty device of the present invention which is indicated in FIG. 1 through FIG. 4 and in FIG. 26 and FIG. 27 is an example which is configured of (1) a base 1 which has a recessed part 12 located in the middle into which the area of the body to be treated is inserted or placed; (2) a drive mechanism 13 which is retained on at least one side of the aforementioned base 1; and (3) rotating treatment members 2 which are disposed so that they are parallel to drive mechanism 13 in the middle of the base 1 and so that they interlock with the aforementioned drive mechanism and rotate.

As indicated in FIG. 1 through FIG. 4, in the aforementioned base 1, retaining members 15 interlock with (1) a pair of curved members or plates 14 and 14 which have a recessed part 12 in the middle; and (2) an attachment belt 4, indicated in FIG. 26 and FIG. 27. Retaining members 15 are disposed between the curved members 14 and 14 and space same at equal distances from one another. Multiple rotating treatment members 2 are disposed along the recessed part 12 between this pair of curved members 14 and 14 so that they rotate. Each of the rotating treatment members 2 makes contact with the treatment area which is placed inside recessed part 12 in order to provide a rubbing treatment.

Gear case 16 contains working gear 22 which is used to rotate the aforementioned rotating treatment member 2 on at least one of the inside surfaces of the curved members 14 and 14. Treatment members 2 interlock with the aforementioned drive mechanism 13 via gear case 16 and are thus rotated, as indicated in FIG. 4. Gear case 16 is disposed so that it forms an integral piece with the respective curved member 14.

Further, this gear case 16 illustrated in the figure is disposed on both of the opposed inside surfaces of curved members 14 and 14. However, the gear case 16 can alternatively be provided on the inside surface of only one of the curved members 14 for rotation of each of the treatment members. In this case, the shaft centers of rotating treatment members 2 should be supported so that same can be inserted and rotatably supported in the side of the other curved member 14.

The aforementioned drive mechanism is retained in gear case 16 of curved member 14 of the aforementioned base 1 so that the drive shaft can be inserted into member 14. Drive gear 131 which interlocks with working gear 22 on the adjacent rotating treatment member 2 is attached to the drive shaft of the aforementioned drive mechanism 13.

At least one of the aforementioned rotating treatment members 2 is disposed in the middle of the aforementioned base 1 along the recessed parts 12 and 12 of both curved members 14 and 14 so that it interlocks with drive mechanism 13 and rotates (FIG. 1, FIG. 3 and FIG. 4 illustrate how the four rotating treatment members 2 are disposed). The aforementioned rotating treatment member 2 is configured of multiple contact members 23 which are attached to and rotate or pivot with the installation shaft 21 so that an integral piece is formed. The aforementioned contact member 23 is disposed so that it protrudes from or beyond the recessed part 12 of the curved member 14 on base 1.

This rotating treatment member 2 may have any shape depending on the objective. However, the embodiment indicated in FIG. 1 and FIG. 4 illustrates use of a rotating treatment member which is provided with (a) a cylindrical member 24 which is placed outside or surrounds the aforementioned installation shaft 21; and (b) a contact member 23 which rotatably mounts four rotating members 26 between a pair of plate-shaped members 25 and 25 which are attached, at constant intervals, to installation shaft 21, as indicated in FIG. 21.

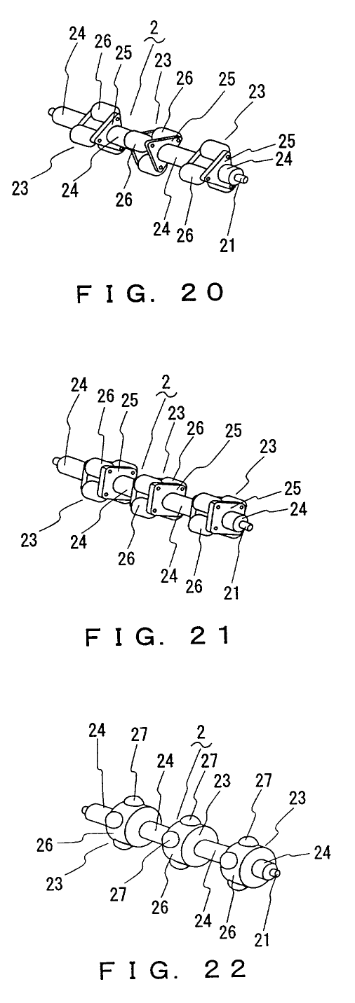

This rotating treatment member 2 may vary in shape as indicated in FIG. 19, FIG. 20 and FIG. 22, and can change the rubbing contact force exerted on the areas of the body to be treated. The rotating treatment member 2 indicated in FIG. 19 is equipped with (a) a cylindrical member 24 which is placed outside the aforementioned installation shaft 21; and (b) a contact member 23 which rotatably mounts four rotating members 26 between a pair of square, plated-shaped members 25 and 25 which are attached at constant intervals to the installation shaft 21. At the same time, the figure illustrates variation of the shaft attachment angle of these contact members 23. For example, the contact member 23 disposed at the center of the installation shaft 21 is skewed or out of alignment with the two endmost contact members 23.

The rotating treatment member 2 indicated in FIG. 20 is provided with (a) a cylindrical member 24 which is placed outside or surrounds the aforementioned installation shaft 21; and (b) contact member 23 which rotatably mounts three rotating members 26 between a pair of triangular plate-shaped members 25 and 25 which are attached, at constant intervals, to the installation shaft 21. At the same time, the shaft attachment angle of these contact members 23 and 23 is varied. In the illustrated embodiment, central contact member 23 is skewed or out of alignment with the two endmost contact members 23.

The rotating treatment member 2 indicated in FIG. 22 is provided with (a) a cylindrical member 24 which is placed outside or surrounds the aforementioned installation shaft 21; and (b) contact member 23 which disposes, at constant intervals, protruding members 27 around a drum-shaped rotating member 26 which is placed outside or surrounds the installation shaft 21 at constant intervals.

A suitable number of the aforementioned retaining members 15 are installed between the curved members 14 and 14 as indicated previously. A velvet fastener or other type of attachment belt 4 which is provided with a latching arrangement, for example, hook-and-loop fastening parts 41 and 42, is inserted between the central retaining member 15 and the two endmost retaining members 15, as indicated in FIG. 26, so that the base 1 can be retained on the area of the body which is being treated.

In addition to the shoulders and the lower back region of the person receiving the treatment, when the thighs and other areas of the body with large diameters are being treated, two attachment belts 4, each of which is provided with fastening parts 41 and 42, are each inserted into the retaining members 15 of one device, and the belts 4 are attached to one another so that the two devices face one another. Bases 1 and 1 of the two devices are disposed so that they are retained on the lower back region, thighs and other areas of the body to be treated with large diameters.

FIG. 27 provides an example in which the treatment areas with large diameters mentioned previously are retained. In this case, attachment belts 4 are each inserted into the retaining members 15 of a respective base 1; the belts 4 are arranged so that the two bases are disposed facing each other as indicated in FIG. 27 and can be maintained so that the bases 1 and 1 are retained in the lower back region, thigh area and other areas with large diameters which are to be treated.

In addition, the multi-form portable health and beauty device in the present invention which is indicated in the practical embodiments in FIG. 5 through FIG. 8 and in FIG. 12 through FIG. 18 is provided with support parts 11 and 11 which can be held on both sides and which are configured of (1) a base 1 which has a recessed part 12 located in the center into which the parts of the body of be treated can be inserted or placed; (2) a drive mechanism 13 which is placed inside the support part 11 on at least one side of the aforementioned base 1; and (3) a rotating treatment member 2 which is installed so that it is parallel to support part 11 along the recessed part 12 in the middle of the base 1 so that it interlocks with the aforementioned drive mechanism 13 and rotates.

As indicated in each of the figures, the aforementioned base 1 is configured of (a) a pair of curved members 14 and 14 each of which forms a recessed part 12 in the middle of the base; and (b) support parts 11 and 11 which can be held in the hand and which are disposed on the upper portion of both sides of these two curved members 14 and 14. Retaining members 15 are installed as is appropriate on the lower part and at both ends of the device between the aforementioned curved members 14 and 14, at constant intervals, so that members 15 can interlock with the attachment belt 4 indicated in FIG. 26 and FIG. 27. Multiple rotating treatment members 2 are installed so that they rotate along the recessed part 12 between this pair of curved members 14 and 14. Each of the rotating treatment members 2 which are inserted inside the recessed part 12 makes contact with the body, thus providing for a massage treatment.

A working gear 22 which is used to rotate the respective rotating treatment member 2, interlocks with the aforementioned drive mechanism 13 and is stored or housed in at least one of the curved members 14 in the aforementioned base 1. Further, the practical embodiments indicated in FIGS. 8 and 18 illustrate an example in which this working gear 22 is placed inside both curved members 14 and 14.

Further, when dealing with only one curved member 14, the curved member 14 which contains this working gear 22 should be supported so that the shaft of the rotating treatment member 2 can be inserted or rotatably supported in the side of the other curved member 14.

In the practical embodiment indicated in each of the figures, the aforementioned support parts 11 are each shaped like a cylinder and are installed between curved members 14 adjacent the upper parts thereof and on opposite sides of recess 12 so that the base 1 can be held in the hand. As indicated in FIG. 8 and FIG. 16, a drive mechanism 13 is interlocked with multiple treatment members 2 disposed along the recessed part 12 of the base 1 so that treatment members 2 can rotate. Drive mechanism 13 is placed or housed inside one of the support parts 11.

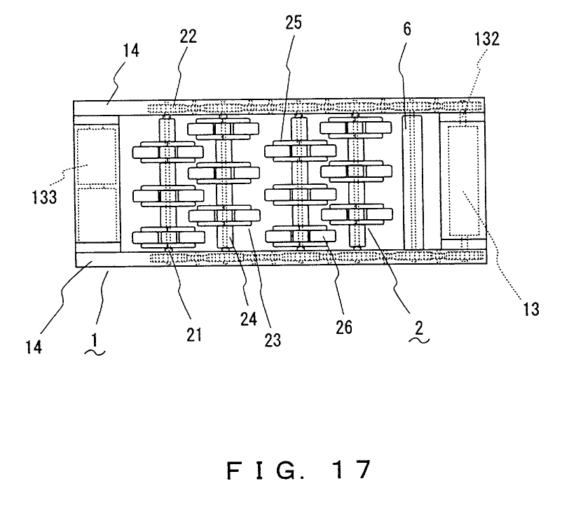

A drive mechanism 13 which has the same schematic weight as the aforementioned drive mechanism 13 may be placed inside the other support part 11 so that the adjoining rotating treatment members 2 are interlocked and rotated from both sides. A drive battery 133 (FIGS. 17 and 18) for the drive mechanism 13 and a vibration mechanism 6 (to be described later on) which imparts vibrations may also be provided. As indicated in the practical embodiment indicated in FIG. 17 and FIG. 18, when a drive battery 133 is placed inside the support part 11 on the side opposite drive mechanism 13, the device is compact and can be easily carried thus making it possible to make the weight on both sides of the base 1 equal.

The aforementioned drive mechanism 13 is retained so that a drive shaft 132 thereof can be inserted into the curved members 14. A drive gear 131 which interlocks with the working gear 22 on the nearby rotating treatment member 2 is attached to the drive shaft 132 of the aforementioned drive mechanism 13.

At least one of the aforementioned rotating treatment members 2 is installed in the middle of the aforementioned base 1 along both recessed parts 12 and 12 of both of the aforementioned curved members 14 and 14 so that it interlocks with the drive mechanism 13 and rotates (FIG. 7, FIG. 8 and FIG. 16 illustrate the disposition of five rotating treatment members 2. FIG. 17 and FIG. 18 illustrate the disposition of four rotating treatment members 2). The aforementioned rotating treatment member 2 should be configured of multiple contact members 23 which are mounted on the installation shaft 21 so that they form an integral piece and so that they rotate with the shaft 21. The aforementioned contact members 23 should be disposed so that they protrude somewhat beyond the recessed part 12 of the curved member 14 on the aforementioned base 1.

These rotating treatment members 2 may have any shape depending on the objective. However, in the embodiments indicated in FIG. 1, FIG. 6 and FIG. 8, rotating treatment members 2 are used which are provided with (a) a cylindrical member 24 which is placed outside of or surrounds the aforementioned installation shaft 21; and (b) a contact member 23 which rotatably mounts two rotating members 26 between a pair of plate-shaped members 25 and 25 which are attached, at constant intervals, to the installation shaft 21.

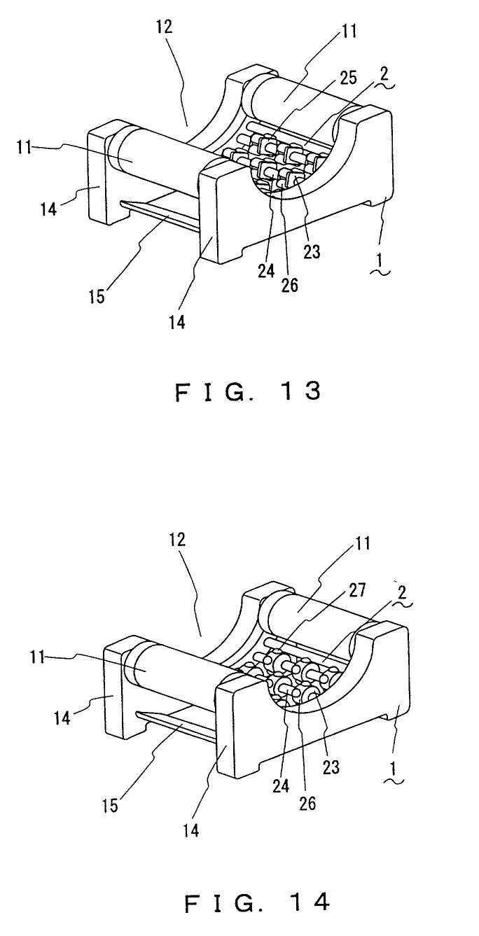

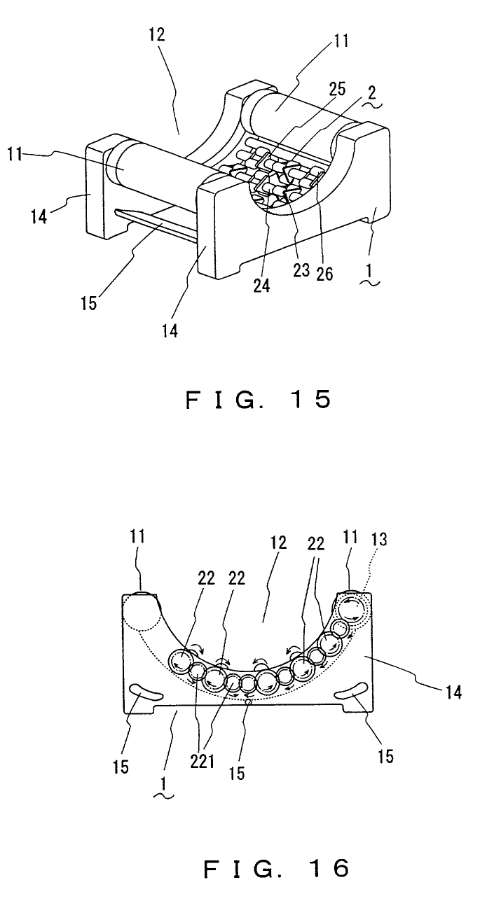

In addition, these rotating treatment members 2 can also have the shape indicated in FIG. 19, FIG. 20, FIG. 21 and FIG. 22 and the rubbing contact force relative to the areas to be treated can be varied as indicated previously. FIG. 12 illustrates the disposition of rotating treatment members 2 indicated previously in FIG. 19. FIG. 13 illustrates the disposition of rotating treatment members 2 indicated previously in FIG. 21. FIG. 14 illustrates the disposition of the rotating treatment members 2 indicated previously in FIG. 22. FIG. 15 illustrates the disposition of rotating treatment members 2 which was indicated previously in FIG. 20.

A suitable number of the aforementioned retaining members 15 are installed between both curved members 14 and 14 as indicated previously. As was indicated previously, a velvet fastener or other type of attachment belt 4 is inserted between the retaining members so as to retain base 1 on the areas of the body to be treated.

In addition, the multi-function health and beauty device in the present invention which was illustrated in the practical embodiments indicated in FIG. 9 through FIG. 11 is configured so that the rotating treatment members 2 are disposed in the schematic middle of the base 1 which has a recessed part in the middle in which the areas of the body to be treated can be inserted or placed. The treatment members 2 interlock with the drive mechanism 13 and rotate. At the same time, expansion and contraction members 3 all of which were used for repeated expansion and contraction or for expansion and retention using air supplied by an air supply means can be provided near both sides of the recessed part of the aforementioned base 1.

The aforementioned rotating treatment members 2 may have any type of structure or shape depending on the objective. However, the practical embodiments indicated in FIG. 9 through FIG. 11 illustrate how a drive mechanism 13 which is provided with a deceleration mechanism is fixed to the inside of a drive tube 28 on which contact members 23 are disposed at constant intervals relative to one another along the periphery; drive shafts 132 and 132 on both sides of the aforementioned drive tube 28 are latched or engaged with the drive mechanism 13 through suitable gears located within one or both of curved members 14 and 14 so that the drive tube 28 itself rotates automatically.

The aforementioned expansion and contraction members 3 are disposed on opposite sides of the recessed part 12 on the aforementioned base 1. FIG. 10 illustrates how repeated expansion and contraction or expansion and retention can be carried out by supplying air to these expansion and contraction members 3 and 3 from an air compressor or air pump or other air supply mechanism 31 (air supply means) through an air hose 32.

The effectiveness of the treatment can be enhanced by using these expansion and contraction members 3. For example, by operating the air supply mechanism 31 so as to repeatedly expand and contract each of the expansion and contraction members 3 and 3 in an expansion and retention mode, pressure treatment can be carried out by using each of the expansion and contraction members 3 and 3. At the same time, by operating the aforementioned drive mechanism 13 and rotating the rotating treatment member 2, treatment can be provided using rotating treatment member 2 while retaining and clamping the areas of the body to be treated using expansion and contraction members 3 and 3. Thus, the treatment effectiveness relative to the areas of the body treated can be enhanced and fat can be burned away at a high synergistic efficiency.

The above-mentioned practical embodiments provided examples of expansion and contraction of the expansion and contraction members 3 using an air compressor, air pump or other type of air supply mechanism 31. However, there are no special restrictions on these and a manually operated pump with a check valve may be used to expand, contract and retain the shape of these members 3.

Further, the aforementioned expansion and contraction members 3 may be configured in two layers, an inside layer and an outside layer. Polyurethane which is effective in preventing leakage of air is effective as the material used for the inside layer. 6-nylon which is effective in preventing excessive expansion should be used as the material for the outside layer. However, there are no particular restrictions on these as long as the materials are capable of being repeatedly expanded and contracted.

As schematically shown in FIG. 28, a control means 5 which controls (a) the rotation and stopping of the rotating treatment members 2 and (b) the repeated expansion and contraction or expansion and retention and stopping of the expansion and contraction members 3 is disposed on the aforementioned drive mechanism 13 and air supply mechanism 31 (air supply means). Automatic treatment relative to the areas treated can be carried out efficiently using the aforementioned control means 5 and fat can be burned away in a highly efficient manner by using the treatment which is appropriate for the areas of the body to treated.

This control means 5 contains microcomputer storage circuit 51 which is used (a) to control the rotation status of the rotating treatment member 2 using the drive mechanism 13; (b) to control the expansion and contraction status of the expansion and contraction members 3 using the air supply mechanism 31; (c) to store the data relating to the rotation speed of the rotating treatment members 2 and the rotation direction and other types of rotation status which are suitable for the areas of the body to be treated; and (d) data relating to the repeated expansion and contraction speed and the expansion, contraction and retention and other types of expansion and contraction status for the expansion and contraction members 3 and the like using a switch S. When the person applying the treatment or the manufacturer sets the data to be stored within storage circuit 51 beforehand, stored data from the storage circuit 51 is sent to the control circuit 52. The data received at the aforementioned control circuit 52 are transferred to operation instruction circuit 53 and sent to drive mechanism 13 and air supply mechanism 31 so that the rotating treatment members 2 can be placed in a rotating status or mode and expansion and contraction members 3 can be placed in an expansion and contraction status or mode based on the setting made.

As a result, when the person receiving the treatment operates the switch S during treatment and indicates any of the operations, treatment using the rotating treatment members and pressure treatment using the expansion and contraction members can be carried out automatically according to the setting made, and body fat can be burned in a highly efficient way using the treatment which is suitable for the areas of the body to be treated.

Further, the outside periphery of the rotating treatment members 2 and expansion and contraction members 3 which are installed on the aforementioned base 1 may be covered as is appropriate using a retractable cover, as is indicated in the practical embodiment illustrated in FIGS. 2, 5 and 11, and the contact stimulation from the rotating treatment member 2 relative to the areas of the body treated can be relaxed or softened by using the aforementioned type of cover.

A suitable number of interposed gears 221 may be placed as desired between each of the working gears 22 and 22 of the adjoining or adjacent rotating treatment members 2 and 2. When an odd number of these interposed gears 221 is provided, the adjacent rotating treatment members 2 and 2 may be rotated in the same direction as one another. When an even number of these interposed gears 221 is provided, the adjacent rotating treatment members 2 and 2 may be rotated in opposite directions from one another (FIGS. 7 and 16).

The practical embodiments illustrate how the aforementioned rotating treatment members 2 are interlocked by interlocking the drive gear 131 on drive mechanism 13 and the working gear 22 of the rotating treatment members 2. However, there are no particular restrictions on these and needless to say, any type of connecting device may be used as long as it interlocks with the drive mechanism 13 and rotates.

Numeral 6 which is indicated in the practical embodiments in FIG. 17 and FIG. 18 is a vibration mechanism which is installed in the recessed part 12 of the base 1 between the respective curved members. This vibration mechanism 6 may be an electromagnetic type or a motor type with an “unbalancer” vibrator. However, by providing these, slight vibrations may be imparted to the inside of recessed part 12 on the base 1 and to the rotating treatment members 2. The slight vibrations which help to burn fat on the treatment areas of the body inside the recessed part 12 can be imparted as appropriate using the aforementioned vibration mechanism 6. In addition, by using this simultaneously with the rotating treatment members 2, fat can be burned away efficiently by using the synergistic treatment effect.

In using the multi-function portable health and beauty device according to the present invention which is configured in this way, a rubbing and rotating treatment, a pressure treatment and a vibration treatment may be selected as is appropriate by plugging in the power source switch and operating the switch S.

As a result, when the multi-function portable health and beauty device in the present invention which is configured as indicated above is used, calves, thigh areas and other areas to be treated can be selected as appropriate for treatment in addition to the upper arm and ankles which the user wishes to treat. At the same time, the device can be used so that either a rubbing treatment, a pressure treatment or a vibration treatment can be selected for use or so that these can be applied simultaneously. When fat is to be burned in the upper arm area, all the user has to do is place her upper arm inside the recessed part 12 of the base of the multi-function portable health and beauty device according to the present invention, as indicated in FIG. 23, and turn on the switch S. The rotating treatment members 2 and the expansion and contraction members 3 or the vibration mechanism are thereby operated while covering the area to be treated. A rubbing treatment, pressure treatment or vibration treatment can be carried out as is appropriate efficiently on the upper arm, the blood circulation in the areas to be treated can be promoted and fat can be burned so that the device is effective in shaping a well-defined upper arm.

In addition, as indicated in FIG. 24, when the user wishes to burn fat on the ankles and calves and other areas all she has to do is place the calves inside the recessed part 12 of the base 1 of the multi-function portable health and beauty device in the present invention and turn on the switch S. This makes it possible for the rotating treatment members 2, the expansion and contraction members 3 or the vibration mechanism 6 to be operated while covering the areas to be treated. The user can apply a rubbing treatment, a pressure treatment or a vibration treatment as appropriate efficiently on the ankles and the calves so that the circulation of the blood in the areas to be treated can be promoted, fat can be burned and well-defined ankles and calves can be shaped.

When the user wishes to burn fat in the thigh areas as indicated in FIG. 25, all she needs to do is place her thighs inside the recessed part 12 of the base 1 of the multi-function portable health and beauty device in the present invention and turn on the switch S. The rotating treatment members 2, the expansion and contraction members 3 or the vibration mechanism 6 are thereby operated while covering the areas to be treated. The user can efficiently carry out a rubbing treatment, a pressure treatment or a vibration treatment as is appropriate on the thigh areas, and circulation of the blood in these areas can be promoted and at the same time fat can be burned, thus making it possible to shape well-defined thighs.

In addition, the multi-function portable health and beauty device in the present invention can be used with an attachment belt 4, as indicated previously. When one of the devices according to the present invention is used as indicated in FIG. 26, the attachment belt 4 is inserted into the device as indicated in the figure and is mounted while the areas to be treated are inserted in recessed part 12 on the base 1 using the aforementioned attachment belt 4. As a result, the user can carry out treatment by mounting the device on the calves and thighs and other parts to be treated in addition to the upper arm and ankles and other areas and turning it freely thereby promoting blood circulation and burning fat without interfering in the user's daily life.

Two of the multi-function portable health and beauty devices in the present invention as indicated in FIG. 27 can also provide treatment which is useful in burning fat on the lower back region, the shoulders and back and other areas of the body with large diameters. For example, when the lower back region is being treated, each of the attachment belts 4 is inserted into one device according to the present invention, as indicated in the figure (when the attachment belt is long, a single attachment belt may be inserted in two of the devices in the present invention). Both sides of the lower back region are placed in the recessed parts 12 of the respective bases 1 using the attachment belt 4. As a result, the person using the device may carry out treatment by mounting the device on the lower back region and other areas to be treated so that it can turned freely. Circulation of the blood can be promoted and fat can be burned without in any way interfering in the daily life of the user.

Further, the aforementioned drive mechanism 13 can be rotated reciprocally. Since multiple mechanisms can be used, rubbing rotation in a clamping state using each of the rotating treatment members 2 and treatment using rubbing rotation in a rubbing state can be applied on any part of the body for treatment by changing the quantity of the drive mechanisms 13 and the direction of rotation. Further, the drive mechanism 13 can be a reversible drive motor so that the treatment members 2 can move in a reciprocating manner (or back and forth) to provide a rubbing type of massage. In this regard, a microcontroller could be provided to control the drive motor.

As indicated previously, the multi-function portable health and beauty device according to the present invention is configured so that a recessed part is formed in the middle of the base in which the areas of the body to be treated are inserted or placed. At the same time, the areas to be treated which are placed inside this recessed part can be treated using the rotating treatment members, the expansion and contraction members or the vibration mechanism. As a result, a large number of rolling members which can rotate freely are disposed around the periphery of the rotor. Unlike prior art portable massage devices which used only point contact with rolling members, the device according to the present invention has a compact design and is inexpensive to manufacture. It can be used efficiently for treatment by using comprehensive or concentrated surface contact from the surrounding area while covering the areas of the body to be treated. Besides promoting circulation of the blood in the areas to be treated and burning fat, the device in the present invention can also be used to treat fatigue.

As a result, the multi-function portable health and beauty device in the present invention is configured so that the rotating treatment members come in contact with one another so that the areas of the body to be treated are covered so that rubbing rotation takes place. It is also configured so that contact is made and the areas to be treated are clamped by the expansion and contraction members and the rotating treatment members cover the areas to be treated thereby providing a rubbing rotation treatment and a pressure treatment using the expansion and contraction members. It is further configured so that contact is made which makes it possible for the rotating treatment members to cover the areas of the body to be treated while imparting vibrations to the areas to be treated using the vibration mechanism and making rubbing rotations, carrying out pressure treatment using the expansion and contraction members while imparting vibrations to the areas of the body to be treated using the vibration mechanism, and at the same time, providing a vibration treatment using the vibration mechanism. As a result, a large number of new treatment effects can be achieved which could not be achieved using the prior art portable massage devices. Besides highly effective promoting of blood circulation and burning of fat suitable for each of the areas of the body to be treated, the device according to the present invention is entirely new and effective in that it can be used to treat fatigue.

Although a particular preferred embodiment of the invention has been disclosed in detail for illustrative purposes, it will be recognized that variations or modifications of the disclosed apparatus, including the rearrangement of parts, lie within the scope of the present invention.

What is claimed is:

1. A multi-function portable health and beauty device comprising a base which has a recessed part in the middle into which an area of the body to be treated is placed, a drive mechanism which is retained on the base, and at least one treatment member installed in the middle of the base so that the treatment member interlocks with the aforementioned drive mechanism and rotates.

2. A multi-function portable health and beauty device comprising a base in the middle of which is formed a recessed part into which an area of the body to be treated can be inserted or placed, a pair of support members disposed on opposite sides of the base, a drive mechanism which is mounted inside at least one of the support members, and at least one rotating treatment member installed in the middle of the base so that the treatment member interlocks with the aforementioned drive mechanism and rotates.

3. The device of claim 1 further including expanding and contracting members which repeatedly expand and contract or expand and retain an expanded shape by supplying air using an air supply means, the expanding and contracting members being disposed on opposite sides of the recessed part of the base.

4. The device of claim 1 including a vibration mechanism disposed on the base which vibrates the inside of the recessed part of the base or vibrates the rotating treatment member on the base.

5. The device of claim 1 wherein the rotating treatment member includes a pair of plate-shaped members which are mounted on an installation shaft disposed in the middle of the base, and multiple rotating members which are disposed between the respective plate-shaped members.

6. The device of claim 2 wherein a second drive mechanism or a drive battery which has the same schematic weight as the first drive mechanism is placed inside the support member on the side of the base opposite the drive mechanism.

7. The device of claim 3 including control means disposed on the drive mechanism or the air supply means, the control means controlling the rotation and stopping of the treatment member and controlling the repeated expansion and contraction or expansion and retention of the expansion and contraction members.

8. The device of claim 2 further including expanding and contracting members which repeatedly expand and contract or expand and retain an expanded shape by supplying air using an air supply means, the expanding and contracting members being disposed on opposite sides of the recessed part of the aforementioned base.

9. The device of claim 2 including a vibration mechanism disposed on the base which vibrates the inside of the recessed part of the base or vibrates the rotating treatment member on the base.

10. The device of claim 2 wherein the rotating treatment member includes a pair of plate-shaped members which are mounted on an installation shaft disposed in the middle of the base, and multiple rotating members which are disposed between the respective plate-shaped members.
